(19) United States
(12) Patent Application Publication
(10) Pub. No.: US 2018/0282189 A1
(43) Pub. Date: Oct. 4, 2018

(54) STRUVITE PRECIPITATION AND MICROBIAL FUEL CELL FOR RECOVERY OF NUTRIENTS AND ENERGY FROM DIGESTER EFFLUENT

(71) Applicants: Jeffrey Allen Cunningham, Temple Terrace, FL (US); Kevin Daniel Orner, Tampa, FL (US); James R. Mihelcic, Temple Terrace, FL (US)

(72) Inventors: Jeffrey Allen Cunningham, Temple Terrace, FL (US); Kevin Daniel Orner, Tampa, FL (US); James R. Mihelcic, Temple Terrace, FL (US)

(73) Assignee: UNIVERSITY OF SOUTH FLORIDA, Tampa, FL (US)

(21) Appl. No.: 15/943,427

(22) Filed: Apr. 2, 2018

Related U.S. Application Data
(60) Provisional application No. 62/480,026, filed on Mar. 31, 2017.

(51) Int. Cl. C02F 3/28; C02F 3/30; C02F 3/34; C02F 11/04; H01M 8/16

(52) U.S. Cl. CPC C02F 3/28; C02F 3/303; C02F 3/341; C01B 25/385; H01M 8/16; C02F 2303/10; C02F 2305/02; C02F 11/04

(57) ABSTRACT

Provided are wastewater treatment processes that involves struvite precipitation and a microbial fuel cell for the recovery of nutrients and energy from a digester effluent.

### CROSS-REFERENCE TO RELATED APPLICATION(S)

This application claims priority to U.S. Provisional Application No. 62/480,026, filed Mar. 31, 2017, incorporated herein by reference in its entirety.

### STATEMENT REGARDING FEDERALLY SPONSORED RESEARCH OR DEVELOPMENT

This invention was made with government support RD835569 awarded by the Environmental Protection Agency and grant 1511439 awarded by the National Science Foundation. The Government has certain rights to the invention.

### BACKGROUND OF THE INVENTION

Water Resource Recovery Facilities remove contaminants prior to discharging treated effluent. Removing nitrogen and phosphorus prevents algae blooms but usually requires expensive energy input. One recent trend in wastewater treatment that can offset these costs is the recovery of resources like nutrients, energy, and water from wastewater. It has been estimated that wastewater contains (as stored chemical energy) approximately 9 times the energy that is required to treat the wastewater to acceptable effluent standards, which can be recovered in part through existing technologies like anaerobic digestion.

In many modern wastewater treatment facilities, a portion of the energy is recovered as methane through anaerobic digestion of primary and/or waste activated sludge (WAS). The nutrient-rich liquid effluent from anaerobic digestion is typically called the “sidestream” and cycled back to the head of the plant. This causes problematic nutrient load variations and decreases the overall nitrogen removal efficiency. It may also increase the cost of wastewater treatment because of additional aeration (for nitrification) and chemical costs (for denitrification, if external electron donors are required). Sidestream recycle is particularly problematic for facilities that carry out enhanced biological phosphorus removal (EBPR), because sidestreams will be highly enriched with phosphate. This can result in difficulty meeting effluent phosphorus limits and/or high chemical costs (e.g. for alum addition).

One prime location for additional resource recovery is the nutrient-rich liquid effluent from anaerobic digestion (sidestream), which is typically cycled back to the head of the plant. The nitrogen remaining in the liquid effluent from struvite precipitation (˜80%) is typically cycled back to the head of the plant, incurring substantial cost, unless a second process is employed along with struvite precipitation. To avoid increased nitrogen loading in the mainstream, efficient nitrogen removal technologies need to be deployed in the sidestream after struvite precipitation. However, nitrogen removal in the sidestream, just like in the mainstream, requires energy input. Existing technologies for sidestream biological nutrient removal (BNR), such as the single reactor system for high-activity ammonium removal over nitrite (SHARON), completely autotrophic nitrogen removal over nitrite (CANON), and anaerobic ammonium oxidation (ANAMMOX), though using less energy than conventional nitrification, still require a net input of energy to remove nitrogen and release N₂ gas to the atmosphere rather than recovering it.

One prominent and established technology that recovers nitrogen (and phosphorus) is struvite precipitation, which may be sold as a nutrient-rich fertilizer. Struvite, defined as magnesium ammonium phosphate, typically recovers 80-90% of phosphorus (P) but only 20% of nitrogen (N) because sidestreams usually contain molar concentrations of N higher than those of P. Anaerobic digestion is utilized in over 10,000 sites in Europe and in 3,500 of 16,000 municipal and industrial wastewater treatment plants in the United States. Of those, at least 25 sites utilize commercial struvite precipitation through technologies such as Ostara Pearl® and NuReSys.

One innovative technology that can remove nitrogen while recovering energy is a bioelectrical system referred to as a microbial fuel cell (MFC). In a MFC, organic or inorganic matter is oxidized to generate current using bacteria. In one section of the MFC, an electron donor is biologically oxidized, releasing electrons, which are transferred exogenously to an electrode (the anode). In the other section of the MFC, the electrons are transferred from an electrode (the cathode) to an electron acceptor, which is reduced. The flow of electrons from the anode to the cathode provides current. This technology differs from the aforementioned BNR technologies because it recovers energy (in the form of electricity) in addition to removing nitrogen. Typically, a microbial fuel cell has a two-chambered design, which utilizes a membrane to separate the anodic chamber from the cathodic chamber. The membrane permits the diffusion of certain chemicals between the two chambers, thereby allowing the desired (bio) chemical reactions to take place in each chamber. Varieties of the two-chamber MFC include rectangular, upflow, U-shaped, and cylindrical configurations. A one-chamber MFC can also be used, which typically exposes the cathode to oxygen in the air and does not need a membrane.

MFCs have been applied to a variety of applications with a variety of fuels. Municipal wastewater has been proposed as a good fuel for MFCs because of the variety of organic substrates present, which can act as electron donors. In most proposed environmental applications of MFCs, molecular oxygen (O₂) serves as the electron acceptor in the cathodic chamber. However, if anaerobic conditions can be maintained, and if the proper microbial populations are present, nitrate or nitrite could serve as the electron acceptor in the cathode. Notably, complete denitrification of NO₃⁻ in the cathodic chamber of a MFC has been achieved. Systems that could simultaneously remove carbon and nitrogen from wastewater while generating electricity have been demonstrated. Additionally, a microbial fuel cell with a separate nitrification stage was utilized to remove nitrogen and obtain power from the liquid effluent of a latrine in Ghana. Similar technologies have been tested in different applications, e.g., treatment of landfill leachate. However, MFCs have not yet been applied for the removal of nitrogen from sidestreams at municipal wastewater treatment plants, nor have been coupled with struvite precipitation to recover N and P.

### SUMMARY OF THE INVENTION

Embodiments of the invention couple microbial fuel cells with struvite precipitation and apply it to digester sidestreams. The long-term impact would be enabling wastewater treatment plants to lower costs by not recycling nitrogen and phosphorus through the mainstream, not requiring the input of energy or chemicals, and producing a valuable slow-release fertilizer.

Removing nutrients from wastewater prevents environmental contamination but usually requires expensive chemical and energy input. Nutrient-rich digestate in the sidestream can utilize struvite precipitation and microbial fuel cells to prevent nutrients from re-entering mainstream treatment, recover energy, and recover a beneficial slow-release fertilizer. For example, results from an 80-day test of a laboratory prototype showed that 97% of phosphorus was recovered by struvite precipitation. The microbial fuel cell removed 61% of nitrogen while generating 61 mW/m³. Results demonstrate that combining struvite precipitation and microbial fuel cells recover nutrients and energy, presenting a promising process to save wastewater treatment plants money by reducing chemical and energy costs.

The present disclosure provides a wastewater treatment process that includes: forming struvite precipitation from a liquid influent processed through a wastewater digester to thereby generate a first liquid effluent with a phosphorus concentration of less than 5%; providing the first liquid effluent to a nitrification reactor to convert ammonium in the first liquid effluent to nitrate or nitrite thereby generating a second liquid effluent; providing the second liquid effluent to a microbial fuel cell, wherein the microbial fuel cell includes an anodic chamber for organic decomposition, a cathodic chamber for denitritation/denitrification; and the microbial fuel cell generating energy and a third liquid effluent substantially free of nitrogen and phosphorus.

The present disclosure provides a wastewater treatment process that includes: digesting waste activated sludge in an anaerobic digester to generate an digester effluent; centrifuging the digester effluent to produce a liquid influent; forming struvite precipitation from the liquid influent to thereby generate a first liquid effluent, wherein the phosphorus concentration in the first liquid effluent is reduced compared to the phosphorus concentration in the liquid influent; providing the first liquid effluent to a fixed-film nitrification reactor to convert ammonium in the first liquid effluent to nitrate or nitrite thereby generating a second liquid effluent comprising nitrate, nitrite, or a mixture thereof; and providing the second liquid effluent and an influent primary wastewater or other electron-donating organic substrate to a microbial fuel cell, wherein the microbial fuel cell comprises an anodic chamber for organic decomposition and a cathodic chamber for denitritation, denitrification, or both, wherein the second liquid effluent is provided to the cathodic chamber and the influent primary wastewater or other electron-donating organic substrate is provided to the anodic chamber, whereby the microbial fuel cell generates energy and a third liquid effluent is generated having reduced amounts of nitrogen and phosphorus compared to the waste activated sludge.

Other aspects of the invention will become apparent by consideration of the detailed description and accompanying drawings.

### BRIEF DESCRIPTION OF THE DRAWINGS

FIG. 1 is a schematic of a treatment process according to an embodiment of the present invention.

FIG. 2 is a graphical illustration of total Nitrogen (“TN”; mg/L TN) in digester effluent, struvite effluent, nitrification effluent, and cathodic effluent. TN was measured over 45 days.

FIG. 3 is a graphical illustration of chemical oxygen demand (COD) (mg/L TN) over time in the influents and effluents of the anodic chamber of the microbial fuel cell. COD was measured over 45 days.

FIG. 4 is a graphical illustration of voltage (mV) and current (μA) over time in the microbial fuel cell.

FIG. 5 is a graphical illustration of the ammonium and phosphate recovery during struvite precipitation. Bar heights are the arithmetic mean values of multiple point measurements taken over a 28 week period; error bars show plus or minus one standard deviation.

FIG. 6A-6B are X-ray diffraction analyses. FIG. 6A is the X-ray diffraction analysis for a representative sample of struvite reactor precipitate. FIG. 6B is the X-ray diffraction analysis for commercially produced struvite from Ostara®. Red peaks represent the struvite counts from the X-Ray Diffraction library; black peaks represent the struvite counts for commercially produced struvite.

FIG. 7 is a graphical illustration of total nitrogen (“TN”; mg/L TN) in struvite effluent, nitrification effluent, and cathodic effluent over 90 days.

FIG. 8 is a graphical illustration of the concentration of total nitrogen (TN, mg/L as N) in struvite reactor influent (stream 3 in FIG. 15), struvite reactor effluent (stream 4 in FIG. 15), fixed-film nitrification effluent (stream 5 in FIG. 15), and cathodic effluent taken (stream 6 in FIG. 15). Bar heights are the arithmetic mean values of multiple point measurements taken over a 28 week period; error bars show plus or minus one standard deviation.

FIG. 9 is a graphical illustration of various nitrogen species (mg/L TN) in the nitrification effluent.

FIG. 10 is a graphical illustration of the nitrogen species in the cathodic influent (stream 5 in FIG. 15) and cathodic effluent (stream 6 in FIG. 15). Bar heights are the arithmetic mean values of multiple point measurements taken over a 28 week period; error bars show plus or minus one standard deviation.

FIG. 11 is a graphical illustration of nitrite in struvite effluent, nitrification effluent, and cathodic effluent over time.

FIG. 12 is a graphical illustration of COD (mg/L COD) over time in the influents and effluents of the anodic chamber of the microbial fuel cell over 90 days.

FIG. 13 is a graphical illustration of mean COD concentration (mg/L) over time in the raw influent and anodic effluent of the microbial fuel cell over a 28 week period.

FIG. 14 is a graphical illustration of mean voltage (mV) and mean current (μA) generation of the microbial fuel cell.

FIG. 15 is a schematic of proposed wastewater treatment and resource recovery process. The numbers indicate the either different sampling locations in the laboratory scale system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The present disclosure relates to a wastewater treatment process that involves struvite precipitation and a microbial fuel cell (MFC) for the recovery of nutrients and energy from a digester effluent. The process includes anaerobic digestion for energy generation, struvite precipitation for nutrient recovery, and an MFC for additional energy generation and nitrogen removal. An effluent from a thermophilic anaerobic digester that is fed with thickened waste activated sludge feeds a struvite precipitation reactor. The struvite precipitation reactor requires the input of magnesium and sodium hydroxide to produce struvite (MgNH₄PO₄). The effluent from the struvite precipitation reactor feeds a nitrification reactor that is aerated to convert NH₄⁺ to NO₂⁻ and/or NO₃⁻. The stream containing NO₂⁻/NO₃⁻ then feeds the cathodic chamber of a microbial fuel cell. The anodic chamber is fed with a stream containing an electron donor. The disclosed wastewater treatment process demonstrates how anaerobic digestion, struvite precipitation, and MFCs can be integrated in domestic wastewater treatment to recover energy and nutrients, while simultaneously reducing the undesirable recycling of nutrients from sidestreams back to mainstream treatment.

The MFC generates energy from the digester effluent or sidestream after struvite precipitation while also further removing nitrogen. In the anodic chambers of MFCs, organic compounds are oxidized to release electrons, which are transferred exogenously to the anode. Through the circuit, the electrons are transferred to the cathode, released, and consumed by electron acceptors. In the proposed new ‘sidestream’ MFC, the electron acceptor could be nitrate or nitrite, which would be converted to nitrogen gas and removed. This proposed technology differs from the aforementioned BNR technologies because it would recover energy (in the form of electricity) in addition to removing nitrogen. The benefit of the MFC in the disclosed process is its ability to remove additional nitrogen in addition to its ability to produce energy. The sidestream nutrient removal prevents nutrients from returning to mainstream treatment, reducing operational costs.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are hereby incorporated by reference in their entirety. The materials, methods, and examples disclosed herein are illustrative only and not intended to be limiting.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

“About” is used synonymously herein with the term “approximately.” Illustratively, the use of the term “about” indicates that values slightly outside the cited values, namely, plus or minus 10%. Such values are thus encompassed by the scope of the claims reciting the terms “about” and “approximately.”

### 2. Wastewater Treatment Process

The present invention is directed to a wastewater treatment process that includes: forming struvite precipitation from a liquid influent (also referred herein as liquid stream or sidestream) processed through a wastewater digester, such as an anaerobic digester, to thereby generate a first liquid effluent with a phosphorus concentration of less than 5%; providing the first liquid effluent to a nitrification reactor to convert ammonium in the first liquid effluent to nitrate or nitrite thereby generating a second liquid effluent; providing the second liquid effluent to a microbial fuel cell, wherein the microbial fuel cell includes an anodic chamber for organic decomposition, a cathodic chamber for denitritation/denitrification; and the microbial fuel cell generating energy and a third liquid effluent substantially free of nitrogen and phosphorus.

The present invention is also directed to a wastewater treatment process that includes: digesting waste activated sludge in an anaerobic digester to generate an digester effluent; centrifuging the digester effluent to produce a liquid influent (also referred herein as liquid stream or sidestream); forming struvite precipitation from the liquid influent to thereby generate a first liquid effluent, wherein the phosphorus concentration in the first liquid effluent is reduced compared to the phosphorus concentration in the liquid influent; providing the first liquid effluent to a fixed-film nitrification reactor to convert ammonium in the first liquid effluent to nitrate or nitrite thereby generating a second liquid effluent comprising nitrate, nitrite, or a mixture thereof; and providing the second liquid effluent and an influent primary wastewater or other electron-donating organic substrate to a microbial fuel cell, wherein the microbial fuel cell comprises an anodic chamber for organic decomposition and a cathodic chamber for denitritation, denitrification, or both, wherein the second liquid effluent is provided to the cathodic chamber and the influent primary wastewater or other electron-donating organic substrate is provided to the anodic chamber, whereby the microbial fuel cell generates energy and a third liquid effluent is generated having reduced amounts of nitrogen and phosphorus compared to the waste activated sludge.

In some embodiments, the nitrogen concentration in the first liquid effluent can be reduced in the fixed-film nitrification reactor. In some embodiments, the nitrogen concentration in the first liquid effluent can be reduced between about 20% and about 60%, between about 25% and about 60%, between about 30% and about 60%, between about 40% and about 60%, between about 20% and about 50%, between about 25% and about 50%, between about 30% and about 50%, or between about 40% and about 50% in the fixed-film nitrification reactor. For example, the nitrogen concentration in the first liquid effluent can be reduced by at least about 20%, at least about 25%, at least about 30%, at least about 35%, at least about 37%, at least about 40%, at least about 45%, at least about 50%, at least about 55%, or at least about 60% in the fixed-film nitrification reactor.

In some embodiments, the phosphorus concentration in the first liquid effluent can be reduced compared to the phosphorus concentration in the liquid influent. In some embodiments, the nitrogen concentration in the first liquid effluent can be reduced between about 40% and about 99%, between about 50% and about 99%, between about 60% and about 99%, between about 70% and about 99%, between about 80% and about 99%, between about 90% and about 99%, between about 40% and about 97%, between about 50% and about 97%, between about 60% and about 97%, between about 70% and about 97%, between about 80% and about 97%, between about 90% and about 97%, between about 40% and about 90%, between about 50% and about 90%, between about 60% and about 90%, between about 70% and about 90%, between about 80% and about 90%, between about 40% and about 80%, between about 50% and about 80%, between about 60% and about 80%, between about 70% and about 80%, between about 40% and about 70%, between about 50% and about 70%, or between about 60% and about 70% compared to the phosphorus concentration in the liquid influent. For example, the phosphorus concentration in the first liquid effluent can be reduced by at least about 20%, at least about 25%, at least about 30%, at least about 35%, at least about 37%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 97%, or at least about 99% compared to the phosphorus concentration in the liquid influent.

In some embodiments, the third liquid effluent can have at least about 50% less phosphorus and/or nitrogen compared to the waste activated sludge. In some embodiments, the third liquid effluent can have at between about 50% and about 99%, between about 60% and about 99%, between about 70% and about 99%, between about 80% and about 99%, between about 90% and about 99%, between about 50% and about 97%, between about 60% and about 97%, between about 70% and about 97%, between about 80% and about 97%, between about 90% and about 97%, between about 50% and about 90%, between about 60% and about 90%, between about 70% and about 90%, between about 80% and about 90%, between about 50% and about 80%, between about 60% and about 80%, between about 70% and about 80%, between about 50% and about 70%, or between about 60% and about 70% less phosphorus and/or nitrogen compared to the waste activated sludge. In some embodiments, the third liquid effluent can have at between about 50% and about 99%, between about 60% and about 99%, between about 70% and about 99%, between about 80% and about 99%, between about 90% and about 99%, between about 50% and about 97%, between about 60% and about 97%, between about 70% and about 97%, between about 80% and about 97%, between about 90% and about 97%, between about 50% and about 90%, between about 60% and about 90%, between about 70% and about 90%, between about 80% and about 90%, between about 50% and about 80%, between about 60% and about 80%, between about 70% and about 80%, between about 50% and about 70%, or between about 60% and about 70% less phosphorus and nitrogen compared to the waste activated sludge. In some embodiments, the third liquid effluent can have at between about 50% and about 99%, between about 60% and about 99%, between about 70% and about 99%, between about 80% and about 99%, between about 90% and about 99%, between about 50% and about 97%, between about 60% and about 97%, between about 70% and about 97%, between about 80% and about 97%, between about 90% and about 97%, between about 50% and about 90%, between about 60% and about 90%, between about 70% and about 90%, between about 80% and about 90%, between about 50% and about 80%, between about 60% and about 80%, between about 70% and about 80%, between about 50% and about 70%, or between about 60% and about 70% less phosphorus compared to the waste activated sludge. In some embodiments, the third liquid effluent can have at between about 50% and about 99%, between about 60% and about 99%, between about 70% and about 99%, between about 80% and about 99%, between about 90% and about 99%, between about 50% and about 97%, between about 60% and about 97%, between about 70% and about 97%, between about 80% and about 97%, between about 90% and about 97%, between about 50% and about 90%, between about 60% and about 90%, between about 70% and about 90%, between about 80% and about 90%, between about 50% and about 80%, between about 60% and about 80%, between about 70% and about 80%, between about 50% and about 70%, or between about 60% and about 70% less nitrogen compared to the waste activated sludge.

For example, the third liquid effluent can have at least about 50%, at least about 55%, at least about 60%, at least about 61%, at least about 65%, at least about 70%, at least about 73%, at least about 74%, at least about 75%, at least about 80%, at least about 85%, at least about 90%, at least about 95%, at least about 97%, or at least about 99% less phosphorus and/or nitrogen compared to the waste activated sludge. In some embodiments, the third liquid effluent can have at least about 50%, at least about 55%, at least about 60%, at least about 61%, at least about 65%, at least about 70%, at least about 73%, at least about 74%, at least about 75%, at least about 80%, at least about 85%, at least about 90%, at least about 95%, at least about 97%, or at least about 99% less phosphorus and nitrogen compared to the waste activated sludge. In some embodiments, the third liquid effluent can have at least about 50%, at least about 55%, at least about 60%, at least about 61%, at least about 65%, at least about 70%, at least about 73%, at least about 74%, at least about 75%, at least about 80%, at least about 85%, at least about 90%, at least about 95%, at least about 97%, or at least about 99% less phosphorus compared to the waste activated sludge. In some embodiments, the third liquid effluent can have at least about 50%, at least about 55%, at least about 60%, at least about 61%, at least about 65%, at least about 70%, at least about 73%, at least about 74%, at least about 75%, at least about 80%, at least about 85%, at least about 90%, at least about 95%, at least about 97%, or at least about 99% less nitrogen compared to the waste activated sludge. In some embodiments, the third liquid effluent is substantially free of phosphorus and/or nitrogen, such as comprising trace amounts of phosphorus and/or nitrogen.

In some embodiments, the liquid effluent from struvite precipitation can be fed into the nitrification chamber. In some embodiments, the nitrification can use an energy input to provide oxygen in the form of aeration, such as from a fish-tank aeration stone. In some embodiments, the process can further include providing aeration to the nitrification reactor, such as a fixed-film nitrification reactor. In some embodiments, aeration can be from a fish-tank aeration stone. In other embodiments, aeration can be from an air diffusion aerator, a pump-fed aerator, a mechanical aerator, or a floating/surface aerator. In some embodiments, the average concentration of dissolved oxygen (DO) in the nitrification reactor can be 6.5 mg/L. In some embodiments, the average hydraulic residence time in the fixed-film nitrification reactor can be 5.8 weeks. In some embodiments, to prevent wash-out of the nitrifying bacteria, plastic carriers (hollow, 1-cm diameter) can be placed in the reactor to support biofilm growth. In some embodiments, the nitrification effluent (a second liquid effluent) can be fed into cathodic chamber of the WC. In some embodiments, the nitrification reactor, such as a fixed-film nitrification reactor, can reduce the nitrogen concentration in the struvite precipitate effluent (first liquid effluent) by at least about 25%, e.g. 30%, 35%, 40%, 45%, 50%, 55%, 60% or more.

In some embodiments, the second liquid effluent can include more nitrate than nitrite. In some embodiments, the second liquid effluent can include more nitrite than nitrate.

In some embodiments, the struvite precipitation reactor can be operated in batch mode. In some embodiments, the nitrification reactor and the microbial fuel cell can be operated continuously and can be fed at discrete intervals. In some embodiments, anodic, cathodic effluent, and fixed-film nitrification effluent can be removed and replaced with the appropriate feed streams. In some embodiments, deionized water can be added as needed to maintain a constant reactor volume.

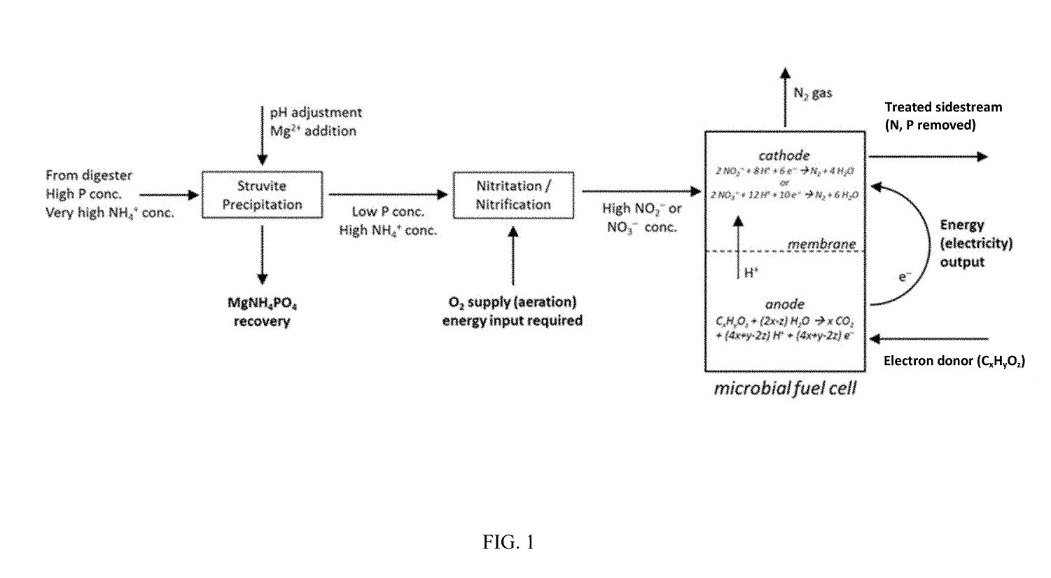

In some embodiments, the microbial fuel cell can include three chambers: 1) an anodic chamber for organic decomposition, 2) a cathodic chamber for denitrification, and 3) a nitrification chamber. In some embodiments, the anodic chamber contains or is provided an influent, such as an influent primary wastewater or other electron-donating organic substrate, as shown in FIG. 1. In some embodiments, the influent can be filtered primary effluent, such as a filtered raw wastewater. In some embodiments, the influent primary wastewater or other electron-donating organic substrate can include glucose.

In some embodiments, the wastewater treatment system includes three components: 1) a struvite precipitation reactor, 2) a fixed-film nitrification reactor, and 3) a microbial fuel cell (MFC) composed of two chambers; an anodic chamber for organic decomposition and a cathodic chamber for denitrification.

The reactions in the three chambers can be represented as the following for nitrification and denitrification:

Anode: C₆H₁₂O₆+6H₂O→6 CO₂+24H⁺+24e⁻ E⁰′(V)=−0.43
Cathode: 2.4*(2NO₃⁻+12H⁺+10e⁻→N₂+6H₂O) E⁰′(V)=+0.75
Overall: C₆H₁₂O₆+4.8NO₃⁻+4.8H⁺→6CO₂+2.4N₂+8.4H₂O E⁰′(V)=+1.18

If nitrite is the electron acceptor in the cathode instead of nitrate, the reactions become the following:

Anode: C₆H₁₂O₆+6H₂O→6CO₂+24H⁺+24e⁻ E⁰′(V)=−0.43
Cathode: 4*(2NO₂⁻+8H⁺+6e⁻→N₂+4H₂O) E⁰′(V)=+0.96
Overall: C₆H₁₂O₆+8NO₂⁻+8H⁺→6CO₂+4N₂+10H₂O E⁰′(V)=+1.39

In some embodiments, the glass reactors for the anodic and cathodic chambers of the MFC can each have a volume of 100 mL and have an opening for a CMI-7000 cation exchange membrane. In some embodiments, the glass reactors for the anodic and cathodic chambers can each contain a graphite electrode and are separate by a cation exchange membrane. In some embodiments, the anode and cathode inside the chambers can be made of 0.5 mg/cm2 60% Platinum on Vulcan-Carbon Paper from the Fuel Cell Store (College Station, Tex.), and each can have a surface area of 6.45 cm2. In some embodiments, anoxic conditions are maintained in both the anodic and cathodic chambers. Voltage and current in the MFC were measured with a Keithley 2701 digital multimeter (Solon, Ohio) in closed-circuit mode.

In some embodiments, the anodic chamber of the MFC is inoculated with Shewanella bacteria, such as Shewanella putrefaciens, Geobacter bacteria, such as Geobacter metallireducens, Rhodoferax ferrireducens, or Desulfobulbus propionicus. In some embodiments, the cathodic chamber of the MFC is inoculated with Geobacter bacteria, such as Geobacter metallireducens, Shewanella bacteria, such as Shewanella putrefaciens, Rhodoferax ferrireducens, or Desulfobulbus propionicus. In some embodiments, the anodic chamber of the MFC is inoculated with Shewanella putrefaciens and the cathodic chamber of the MFC is inoculated with Geobacter metallireducens.

In some embodiments, the anodic chamber of the MFC contains or is provided an influent, such as an influent primary wastewater or other electron-donating organic substrate. In some embodiments, the influent can be filtered primary effluent, such as a filtered raw wastewater or filtered wastewater. In some embodiments, the influent primary wastewater or other electron-donating organic substrate can include glucose.

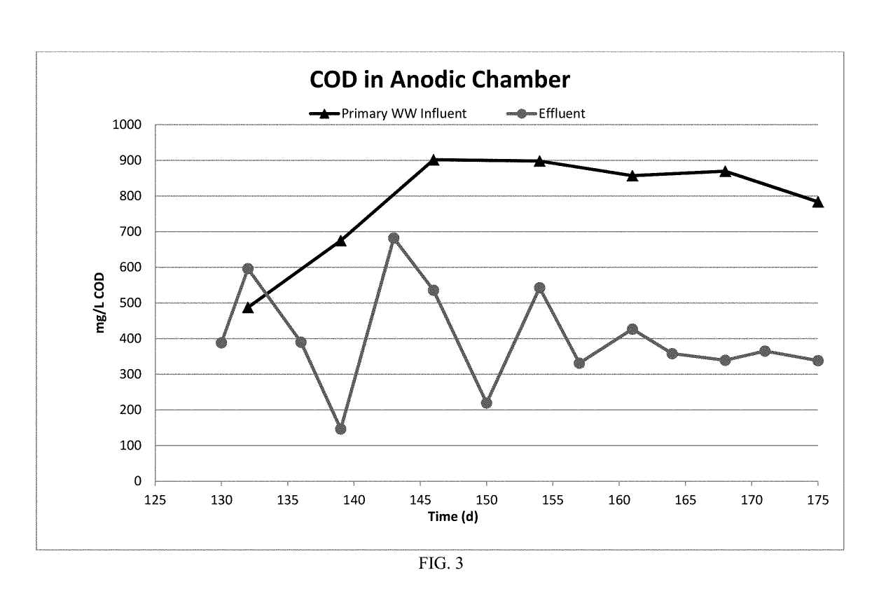

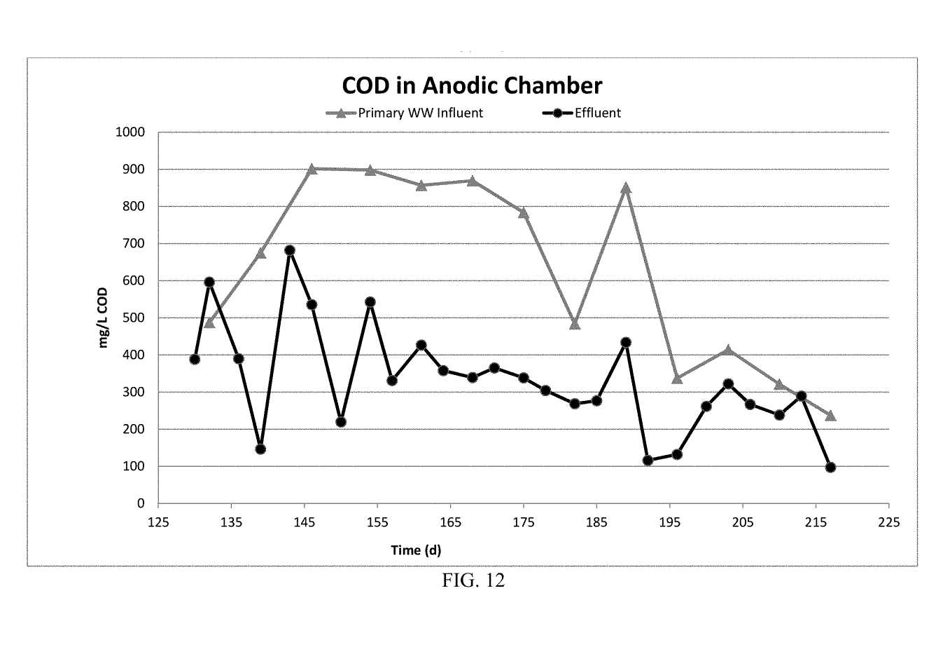

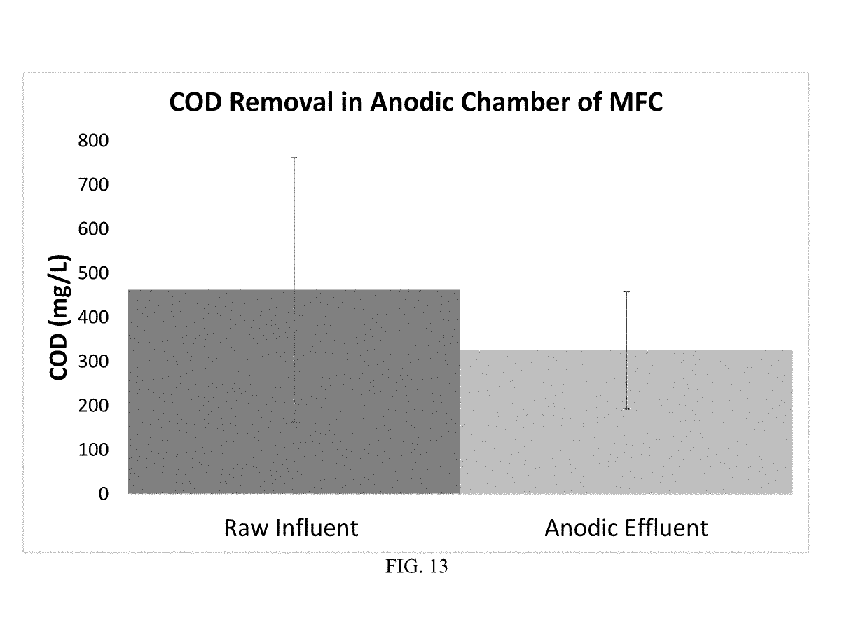

In some embodiments, the microbial fuel cell removes at least about 25% of the influent wastewater chemical oxygen demand, e.g. 30%, 35%, 40%, 45%, 50%, 55%, 60%, 65%, or more. With reference to FIG. 3, in the anodic chamber, the influent primary wastewater COD can be removed. In some embodiments, the anodic chamber can remove up to about 40% of the influent primary wastewater COD, even as the total COD in the influent decreased (FIG. 12). In some embodiments, an average of approximately 30% of the COD can be removed in the anodic chamber over the course of the 28 week study (FIG. 13). In some embodiments, at least about 25% to about 60%, at least about 30% to about 60%, at least about 25% to about 50%, at least about 30% to about 50%, at least about 25% to about 40%, or at least about 30% to about 40% of the influent primary wastewater COD can be removed. For example, at least about 25%, at least about 30%, at least about 35%, at least about 40%, at least about 45%, at least about 49%, at least about 50%, at least about 51%, at least about 55%, or at least about 60% of the influent primary wastewater COD can be removed.

In some embodiments, nitrate is the electron acceptor in the cathodic chamber for electrons that are released in the anodic chamber. In some embodiments, nitrite is the electron acceptor in the cathodic chamber for electrons that are released in the anodic chamber.

In some embodiments, the sidestream (liquid influent) can be used as an influent for struvite precipitation. In some embodiments, the liquid effluent of struvite precipitation (first liquid effluent) can be the influent to the nitrification chamber or reactor, such as a fixed-film nitrification reactor. In some embodiments, the sidestream can be produced by an anaerobic digester. In the nitrification chamber or reactor, such as a fixed-film nitrification reactor, the ammonium from the influent can be converted to nitrate (or nitrite), which can serve as the cathodic chamber influent. In some embodiments, the nitrification chamber or reactor, such as a fixed-film nitrification reactor can serve as the influent for the cathodic chamber of the MFC. In some embodiments, in the cathodic chamber, nitrate can be the electron acceptor for electrons that are released in the anodic chamber. In some embodiments, in the cathodic chamber, nitrate or nitrite, formed in the nitrification reactor, can accept the electrons that are released in the anodic chamber. In some embodiments, the microbial fuel cell can reduce the nitrogen concentration in the nitrification reactor effluent (second liquid effluent) by at least about 15%, e.g. 20%, 25%, 30%, 35%, 40%, 45%, or more as compared to the first liquid effluent, liquid influent, and/or waste activated sludge.

In some embodiments, the wastewater treatment process described herein can reduce the total nitrogen concentration in the sidestream by at least about 70%, e.g. 75%, 80%, 85%, 90%, 95%, or more.

In some embodiments, thickened waste activated sludge (3-4% by mass from the Hillsborough County Falkenberg Facility (Tampa, Fla.) can be fed into a 20-liter thermophilic (55° C.) anaerobic digester. In some embodiments, struvite precipitation can be achieved by daily combining the two liters of liquid effluent from the digester with MgCl₂*6H₂O and by adjustment of pH to approximately 8.5. In some embodiments, the pH may be adjusted to a range of 8 to 9, 7.5 to 8.5, 8 to 9.5, 7.5 to 9.5, or 8.5 to 9.5. In some embodiments, struvite seed crystals can be added to aid in the nucleation of the precipitate. In some embodiments, the struvite reactor can be operated at a mixing speed of approximately 150 rpm for 8-10 minutes to allow precipitation to occur. In some embodiments, solids can be separated from the liquid phase via centrifugation at 5000 rpm for 20 min. In some embodiments, the struvite precipitation can recover at least about 70% of the phosphate in the digester sidestream or digester effluent, e.g. 75%, 80%, 85%, 90%, 95%, or more. In some embodiments, the struvite precipitation can recover at least about 5% of the ammonium in the digester sidestream or digester effluent, e.g. 10%, 15%, 20%, 25%, 30%, or more.

In some embodiments, the process can further include adjusting the pH of the liquid influent. In some embodiments, the pH of the liquid influent can be adjusted to between 8 and 9, between 7.5 and 8.5, between 8 and 9.5, between 7.5 and 9.5, or between 8.5 and 9.5. In some embodiments, the pH of the liquid influent can be adjusted to 8.5.

In some embodiments, struvite precipitation can be achieved by adding MgCl₂.6H₂O to the liquid influent to achieve a Mg:P molar ratio of 1.6-2.

In some embodiments, the anaerobic digester can be a thermophilic anaerobic digester, such as at a temperature above 50° C.

In some embodiments, the WAS can include at least about 3% by mass volatile solids concentration feed sludge. In some embodiments, the WAS can include between at least about 1% to about 5% by mass volatile solids concentration feed sludge.

Nitrogen can be monitored using standard methods (APHA, 2012) for nitrogen species (NH₄⁺, NO₂⁻, NO₃⁻) in the nitrification reactor, chemical oxygen demand (COD) in the feed stream to the anodic chamber, COD in the effluent of the anodic chamber, total nitrogen concentration in the feed stream to the cathodic chamber, total nitrogen concentration in the effluent of the cathodic chamber, alkalinity and pH in both anodic and cathodic chambers, concentration of total phosphorus in both chambers, dissolved oxygen concentration in the anode, voltage, and current. Samples can be collected and analyzed two times per week. COD, TN, and TP can be analyzed using Hach Kits; ion chromatography can be used to analyze NH₄⁺, NO₂⁻, and NO₃⁻.

A multimeter can measure the voltage and current between the anodic and cathodic chambers. In some embodiments, the microbial fuel cell can generate an average voltage in a range of 0 to 500 mV. In some embodiments, the microbial fuel cell can generate an average voltage of 0 to 500 mV, of 50 to 450 mV, of 100 to 400 mV, of 150 to 350 mV, of 200 to 300 mV, of 50 to 100 mV, of 50 to 200 mV, of 50 to 300 mV, of 50 to 400 mV, of 10 to 500 mV, of 100 to 300 mV, of 200 to 400 mV, of 200 to 500 mV, of 300 to 400 mV, of 300 to 500 mV, of 400 to 500 mV, or of 45 to 500 mV. In some embodiments, the microbial fuel cell can generate an average voltage in a range of 0 to 500 μA. In some embodiments, the microbial fuel cell can generate an average current of 0 to 500 μA, of 50 to 450 μA, of 100 to 400 μA, of 150 to 350 μA, of 200 to 300 μA, of 50 to 100 μA, of 50 to 200 μA, of 50 to 300 μA, of 50 to 400 μA, of 100 to 500 μA, of 100 to 300 μA, of 200 to 400 μA, of 200 to 500 μA, of 300 to 400 μA, of 300 to 500 μA, of 400 to 500 μA, or of 45 to 500 μA.

In some embodiments, the microbial fuel cell can generate power in a range of 0 to 60 mW power per m² of anodic surface area (mW/m²). In some embodiments, the microbial fuel cell can generate at least about 0.1 mW/m², at least about 0.2 mW/m², at least about 0.3 mW/m², at least about 0.4 mW/m², at least about 0.5 mW/m², at least about 1.0 mW/m², at least about 2.0 mW/m², at least about 3.0 mW/m², at least about 4.0 mW/m², at least about 5.0 mW/m², at least about 10.0 mW/m², at least about 15.0 mW/m², at least about 20 mW/m², at least about 25 mW/m², at least about 30 mW/m², at least about 35 mW/m², at least about 40 mW/m², at least about 45 mW/m², at least about 50 mW/m², at least about 55 mW/m², or at least about 60 mW/m². In some embodiments, the microbial fuel cell can generate power of between 0 and 60 mW/m², between 0 and 50 mW/m², between 0 and 40 mW/m², between 0 and 30 mW/m², between 0 and 20 mW/m², between 0 and 10 mW/m², between 10 and 60 mW/m², between 20 and 60 mW/m², between 30 and 60 mW/m², between 40 and 60 mW/m², between 50 and 60 mW/m², between 10 and 50 mW/m², between 10 and 40 mW/m², between 10 and 30 mW/m², between 10 and 20 mW/m², between 20 and 50 mW/m², between 20 and 40 mW/m², between 20 and 30 mW/m², between 30 and 50 mW/m², between 30 and 40 mW/m², or between 40 and 50 mW/m².

In some embodiments, the microbial fuel cell can generate power in a range of 0 to 70 mW power per volume of liquid in each chamber of the MFC (mW/m³). In some embodiments, the microbial fuel cell can generate at least about 0.1 mW/m³, at least about 0.2 mW/m³, at least about 0.3 mW/m³, at least about 0.4 mW/m³, at least about 0.5 mW/m³, at least about 1.0 mW/m³, at least about 1.1 mW/m³, at least about 2.0 mW/m³, at least about 3.0 mW/m³, at least about 4.0 mW/m³, at least about 5.0 mW/m³, at least about 10.0 mW/m³, at least about 15.0 mW/m³, at least about 20 mW/m³, at least about 25 mW/m³, at least about 30 mW/m³, at least about 35 mW/m³, at least about 40 mW/m³, at least about 45 mW/m³, at least about 50 mW/m³, at least about 55 mW/m³, at least about 60 mW/m³, at least about 65 mW/m³, at least about 66 mW/m³, or at least about 70 mW/m³. In some embodiments, the microbial fuel cell can generate power of between 0 and 70 mW/m³, between 0 and 60 mW/m³, between 0 and 50 mW/m³, between 0 and 40 mW/m³, between 0 and 30 mW/m³, between 0 and 20 mW/m³, between 0 and 10 mW/m³, between 10 and 60 mW/m³, between 20 and 60 mW/m³, between 30 and 60 mW/m³, between 40 and 60 mW/m³, between 50 and 60 mW/m³, or between 30 and 50 mW/m³

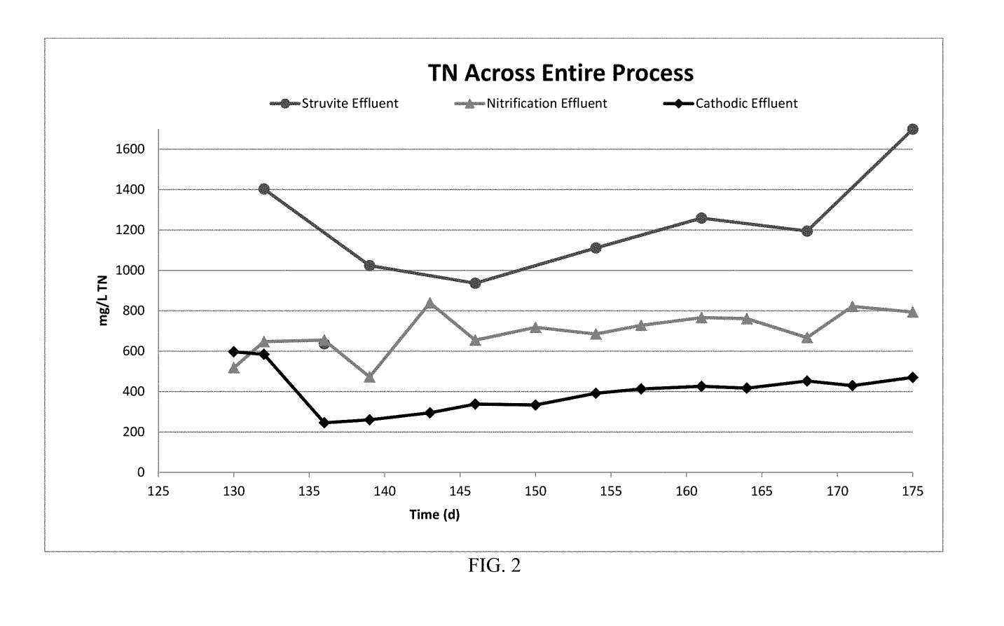

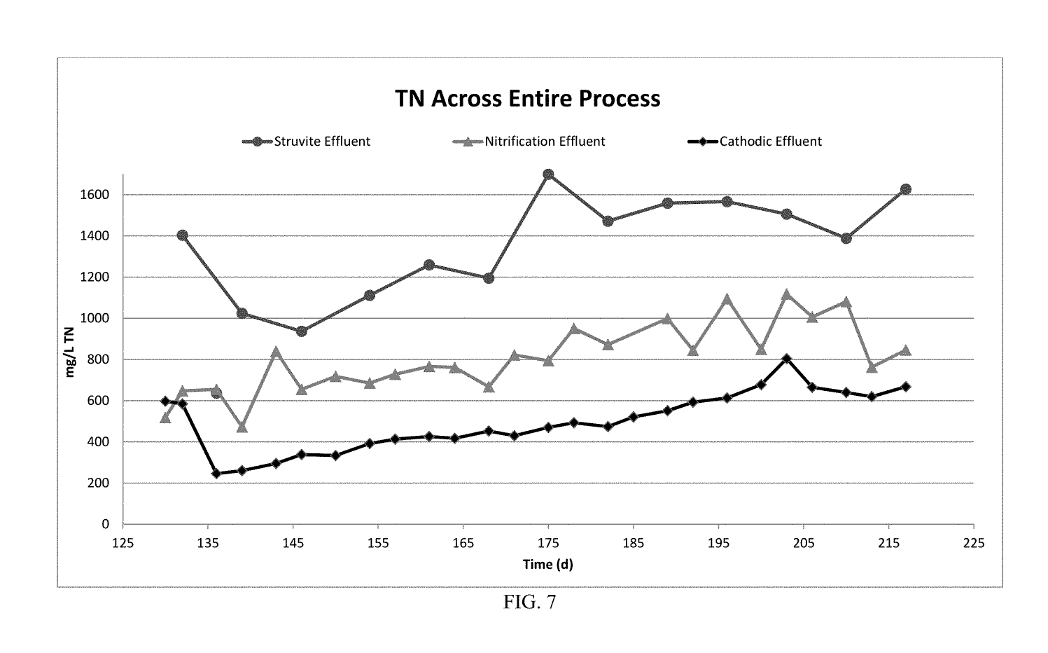

With reference to FIG. 2, the nitrification chamber can decrease the total nitrogen concentration by 40% from the struvite effluent (1500 mg/L TN unfiltered) to the nitrification chamber effluent (1000 mg/L TN unfiltered). During the 45 day and 90 day time periods monitored in FIGS. 2 and 7, the nitrification chamber decreased the total nitrogen concentration by anywhere between 26 and 55%.

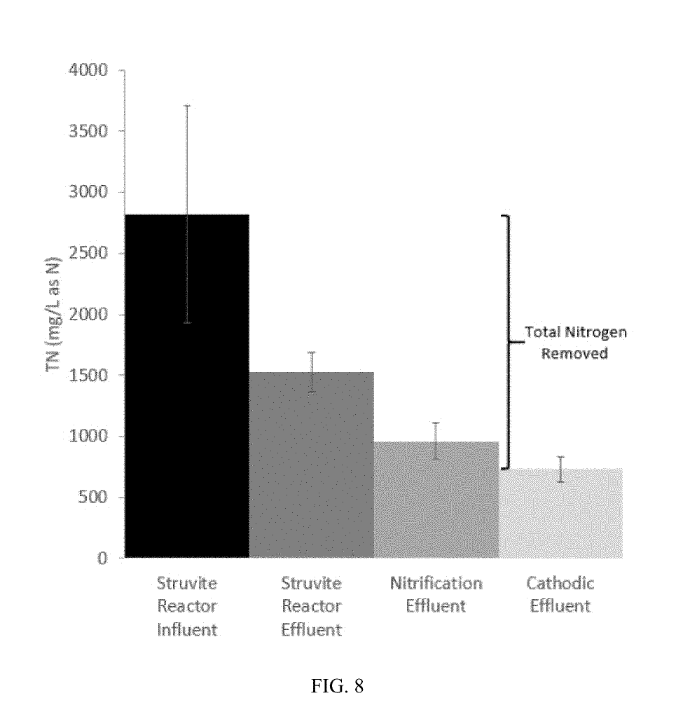

In some embodiments, the fixed-film nitrification reactor effluent, which as described above can include more nitrite than nitrate, can be used as influent to the cathodic chamber of the MFC. In some embodiments, in the cathodic chamber, the average TN can drop an additional 45% to approximately 700 mg/L N, resulting in a combined nitrogen removal percentage of 61%. In some embodiments, the cathodic effluent can have a NH₄⁺—N of 120 mg/L, NO₂⁻—N of 48 mg/L, and NO₃⁻—N of 7 mg/L. In some embodiments, the drop in nitrite from 290 mg/L to 46 mg/L can indicate that the cathodic chamber primarily utilized denitritation to remove nitrogen. In some embodiments, the cathodic effluent can have a NH₄⁺—N of 150±40 mg/L, NO₂⁻—N of 50±20 mg/L, and NO₃⁻—N of 2±2 mg/L mg/L over the 28-week operation period (FIG. 7). In some embodiments, the drop in nitrite from 360 mg/L to 50 mg/L can indicate that the cathodic chamber primarily utilized denitritation to remove nitrogen. As shown in FIG.8, in the cathodic chamber, the average total nitrogen decreased by an additional 24% to approximately 730 mg/L N (SD 110 mg/L). In some embodiments, the overall nitrogen removal can be achieved by the treatment process (i.e., from the digester effluent/struvite influent to the MFC cathode effluent) was on average 74% over the 28-week period of operation (FIG. 8).

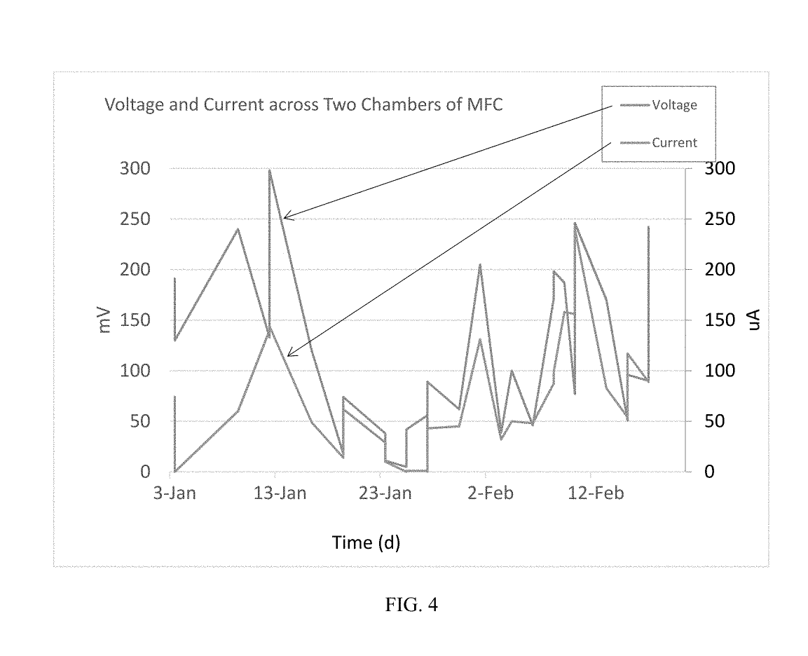

In some embodiments, the standard electrode potential of microbial fuel cells can be 1.2 V for organic decomposition and denitrification (1.4 V for denitritation). However, the voltage range of microbial fuel cells can be 300-700 mV due to losses associated with activation, bacterial metabolism, and mass transport. In some embodiments, the voltage and current can be measured across the two chambers of the MFC throughout the process, as shown in FIG. 4. In some embodiments, the voltage produced can range from 5 to 298 mV over the course of the 33 days. In some embodiments, the current can range from 0 to 229 μA over the same time range. In some embodiments, the microbial fuel cell as disclosed herein can produce an average voltage of 160 mV and an average current of 130 μA, as shown in FIG. 4, therefore generating 15 mW/m² or 66 mW/m³.

### 3. Examples

It will be readily apparent to those skilled in the art that other suitable modifications and adaptations of the methods of the present disclosure described herein are readily applicable and appreciable, and may be made using suitable equivalents without departing from the scope of the present disclosure or the aspects and embodiments disclosed herein. Having now described the present disclosure in detail, the same will be more clearly understood by reference to the following examples, which are merely intended only to illustrate some aspects and embodiments of the disclosure, and should not be viewed as limiting to the scope of the disclosure. The disclosures of all journal references, U.S. patents, and publications referred to herein are hereby incorporated by reference in their entireties.

The present invention has multiple aspects, illustrated by the following non-limiting examples.

### EXAMPLE 1

### Materials and Methods

Experimental Set-up. A bench-scale system was constructed to treat WAS that was collected from the Falkenburg Advanced Wastewater Treatment Plant (Hillsborough County, Fla.). The Falkenburg plant had an annual average influent flow rate of 9.27 million gallons per day (MGD). Permit limits for biochemical oxygen demand (BOD₅), total suspended solids (TSS), total nitrogen (TN), and total phosphorus (TP) were 5, 5, 3, and 1 mg/L, respectively. The plant has no primary treatment but uses anaerobic selectors to initiate EBPR, followed by oxidation ditches for simultaneous nitrification/denitrification (SND), then media filters and UV disinfection. Addition of aluminum sulfate (alum) is also used for chemical phosphorus removal when EBPR is insufficient to meet permit requirements.

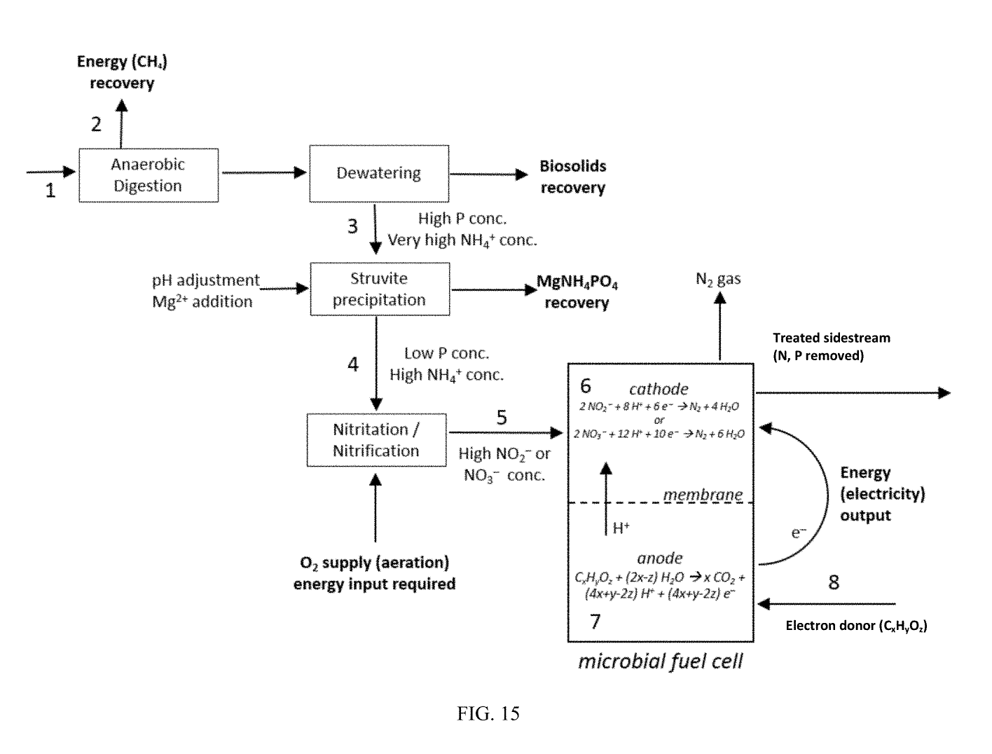

The bench-scale treatment system used to treat the WAS is shown in FIG. 15. It consisted of four components: (1) an anaerobic digester followed by dewatering step that produced a centrifuged sidestream (labeled stream 1 in FIG. 15), (2) a reactor that precipitated struvite (MgNH4PO4.6H2O) from the digester sidestream, (3) a fixed-film nitrification reactor, and (4) anodic and cathodic chambers of the MFC. The struvite precipitation reactor was operated in batch mode. The other four components were operated continuously, but were fed at discrete intervals, as described below.

Anaerobic Digester. Dewatered WAS was collected weekly and diluted with dewatered reject water to produce a 3% (by mass) volatile solids (VS) concentration feed sludge, which is representative of a typical digester feed stream. The feed sludge was introduced into a 30-liter thermophilic (55+/−2 ° C.) anaerobic digester with a working volume of 24 liters (described in detail by Amini et al. Waste Mgmt. (2017) DOI 10.1016/j.wasman.2017.089.041). The digester was mixed by sludge recirculation using a Masterflex L/S pump (Cole Parmer, Vernon Hills, Ill.). To maintain a solids residence time (SRT) of 20 days, digested sludge was removed and influent was added three times per week on Monday, Wednesday, and Friday (3.6 L, 2.4 L, and 2.4 L, respectively). The effluent was centrifuged for 30 minutes at 5000 rpm using an Eppendorf Centrifuge 5810 R (Hamburg, Germany) to produce a liquid stream (sidestream) and introduced to the next treatment step, as described below.

Struvite Precipitation Reactor. Struvite precipitation was achieved in a 3.5-L continuously mixed batch reactor by amending the sidestream with MgCl₂.6H₂O to achieve an Mg:P molar ratio of 1.6-2.0. Also, the pH was adjusted to 8.5 via addition of 2N NaOH, and 1 g/L of struvite seed crystals (obtained from Ostara®) were added to aid in nucleation of precipitate. These conditions were determined per batch tests in a Phipps & Bird PB-700™ Jartester (Richmond, VA). Following chemical addition to the sidestream, the reactor was operated at a mixing speed of approximately 150 rpm for 8-10 minutes to allow precipitation to occur. Solids were then separated from the liquid phase via centrifugation at 5000 rpm for 20 min. The chemical composition of collected solids was analyzed via X-ray powder diffraction (XRD) with a PANalytical X'Pert Materials Research Diffractometer (Westborough, Mass.).

Fixed-Film Nitrification Reactor. The liquid effluent from struvite precipitation (stream 2 in FIG. 15) was fed into the fixed-film nitrification reactor, where it was aerated with a fish-tank aerator to promote nitrification. The average concentration of dissolved oxygen (DO) in the nitrification reactor was 6.5 mg/L. The volume of the fixed-film nitrification reactor was 0.4 L; a total of 0.07 L was removed over three sampling dates each week. Therefore, the average hydraulic residence time (HRT) in the fixed film nitrification reactor was 5.8 weeks. To prevent wash-out of the nitrifying bacteria, plastic carriers (hollow, 1-cm diameter) were placed in the reactor to support biofilm growth.

Microbial Fuel Cell. The MFC consisted of two chambers, each of which was a glass reactor with a volume of 100 mL, joined by a glass bridge with a CMI-7000 cation exchange membrane (Membranes International Inc., Ringwood, N.J.). The influent to the anodic chamber was filtered raw wastewater (stream 6 in FIG. 15), and the influent to the cathodic chamber was the liquid effluent of the fixed-film nitrification reactor (stream 3 in FIG. 15). The electrodes (anode and cathode) inside the chambers were constructed of 0.5 mg/cm² 60% platinum on Vulcan-Carbon Paper (Fuel Cell Store, College Station, Tex.), and each had a surface area of 6.45 cm². Anoxic conditions were maintained in both the anodic and cathodic chambers via a gentle purge with nitrogen gas.

The anode of the MFC was inoculated with Shewanella putrefaciens, and the cathode was inoculated with Geobacter metallireducens, both obtained from the American Type Culture Collection (ATCC) (Manassas, Va.). During a start-up period, the wastewater sources used as influents for the MFC were artificial solutions of glucose (280 mg/L, used as carbon source for organic decomposition) for the anodic chamber and sodium nitrate (340 mg/L, used as nitrate source for denitrification) for the cathodic chamber. Once the MFC was stabilized after about 28 days, the anodic chamber influent was transitioned to filtered raw wastewater from Northwest Regional Water Reclamation Facility (Hillsborough County, Fla.), and the cathodic chamber influent was transitioned to effluent of the fixed-film nitrification reactor, as shown in FIG. 15.

Voltage and current in the MFC were measured with a Keithley 2701 digital multimeter (Solon, Ohio) in closed-circuit mode. A 1000-Ω resistor was placed in the circuit between the anode and cathode to provide a load (external resistance). The external resistance of 1000 Ω was chosen because it generated the greatest power output of the MFC. The selected external resistance was consistent with the estimated internal resistance of 2027 Ω, estimated via the current interrupt method (Aelterman et al., Environ. Sci. Technol. 2006, 40, 3388-3394).

The MFC was operated for 201 days. Anodic, cathodic effluent, and fixed-film nitrification effluent were removed and replaced with the appropriate feed streams. If the liquid volume in the anodic or cathodic chambers remained below 100 mL after replacement (if liquid volume was lost, for example, due to evaporation), deionized water was added to maintain a constant reactor volume.

Sampling and Analysis. Details of analytes measured, analytical methods used, and the analyses done at each sample location are shown in Tables 1 and 2. Anion and cation analysis was performed using a Metrohm Peak 881 AnCat (Herissau, Switzerland) ion chromatography (IC) system.

TABLE 1

| Analyte | Method |
|---|---|
| COD | Standard Method 5220B (APHA, 2012) |
| TN | Standard Method 4500-N (Per Sulfate) (APHA, 2012) |
| TP | Standard Method 4500-P E (APHA, 2012) |
| Ammonium | Ion chromatography with chemical suppression |
| | (USEPA, 1997) |
| Nitrite | Ion chromatography with chemical suppression |
| | (USEPA, 1997) |
| Nitrate | Ion chromatography with chemical suppression |
| | (USEPA, 1997) |
| Orthophosphate | Ion chromatography with chemical suppression |
| | (USEPA, 1997) |

TABLE 2
Sampling Locations and Analyses Conducted for Assessment of the
System Performance

| | | Sampling |
|---|---|---|
| | | Locations |
| Analyte | Method | in FIG. 15 |
| Total Nitrogen | Standard Method 4500-N | 1, 3, 4, 5, 6 |
| | (Persulfate) | |
| Total Phosphorus | Standard Method 4500-P E | 1, 3, 4, 5 |
| Anions (NO₂⁻, NO₃⁻ and PO₄³⁻) | Standard Method 4110B | 1, 3, 4, 5, 6 |
| Cations (NH₄⁺, Mg₂⁺, Ca₂⁺) | ISO 14911 | 1, 3, 4, 5, 6 |
| | (ion chromatography) | |
| Alkalinity | Standard Method 8221 | 4, 5, 6, 7, 8 |
| Dissolved Oxygen | Thermo Scientific Orion | 4, 5, 6, 7, 8 |
| | (Waltham, MA) | |
| pH | Thermo Scientific Orion | 4, 5, 6, 7, 8 |
| | (Waltham, MA) | |
| Biogas Flow and Methane | Standard Method 1827 | 2 |
| Content | | |
| Total Solids and Volatile | Standard Methods 2540 | 1, 3 |
| Solids | | |
| Chemical Oxygen Demand | Standard Method 5220B | 1, 3, 7, 8 |

### EXAMPLE 2

### Methane and Energy Production During Anaerobic Digestion

During thermophilic digestion, 1,570±85 mg NH₄⁺—N/L was released into the liquid fraction of the digester, which resulted in the overall concentration of 1,680±150 mg NH₄⁺N/L in the digester effluent. Because the digester was fed with EBPR sludge with high P content, a release of 220±35 mg PO₄³—P/L (SD 35 mg/L) was also observed. Thus, high concentrations of both nitrogen and phosphorus in the effluent of the thermophilic anaerobic digester made them accessible for nutrient recovery.

Volatile solids (VS) reduction is affected by the type of sludge fed into the digester (primary, WAS, or a mixture of sludges). The reduction of VS in the digester fed with WAS was 22%, which is lower than the range of 38-43% reported by Gianico et al. (Bioresour. Technol. (2013) 143, 96-103) who also treated WAS in a thermophilic anaerobic digester. In comparison, a 40-53% VS reduction has been observed in a thermophilic digester fed with a mixture of pre-thickened primary and secondary WAS.

The methane content of the produced biogas was 64±1.2%, which is within a typical reported range of 60-70%. Based on the measured volume of the biogas and its methane composition as well as VS reduction, the calculated methane yield was 0.2±0.08 m³ CH₄/kgVS. In comparison, Gianico et al. (2013) observed a methane yield of 0.26-0.31 m³ CH₄/kgVS, whereas others reported a methane yield of 0.35-0.43 m³ CH₄/kgVS. The low VS reduction and methane yield observed can be due to the high sludge age (25-30 days) of WAS used as a feed in the current experiment. Based on the assumed heat value of methane of 36 MJ/m³ CH₄, the produced methane results in an average power production of 2.3 W.

### EXAMPLE 3

### Nitrogen and Phosphorus Removal During Struvite Precipitation

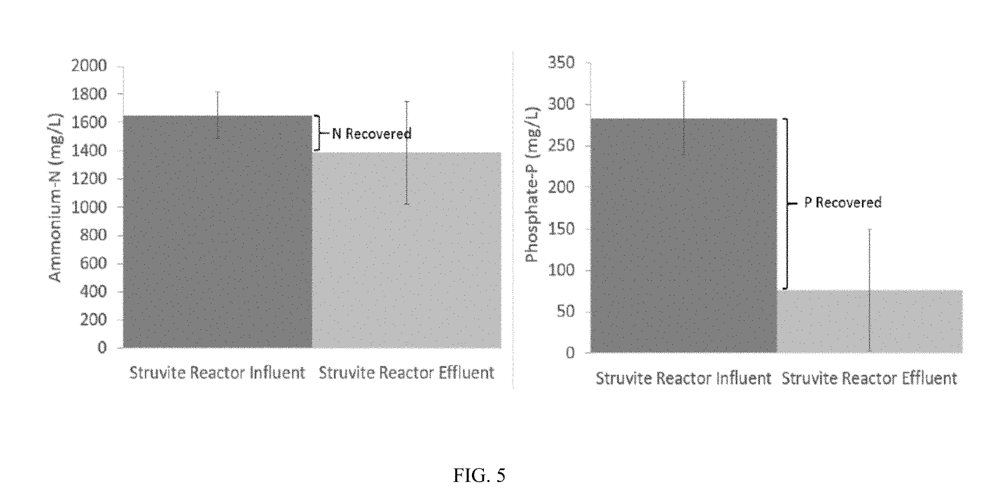

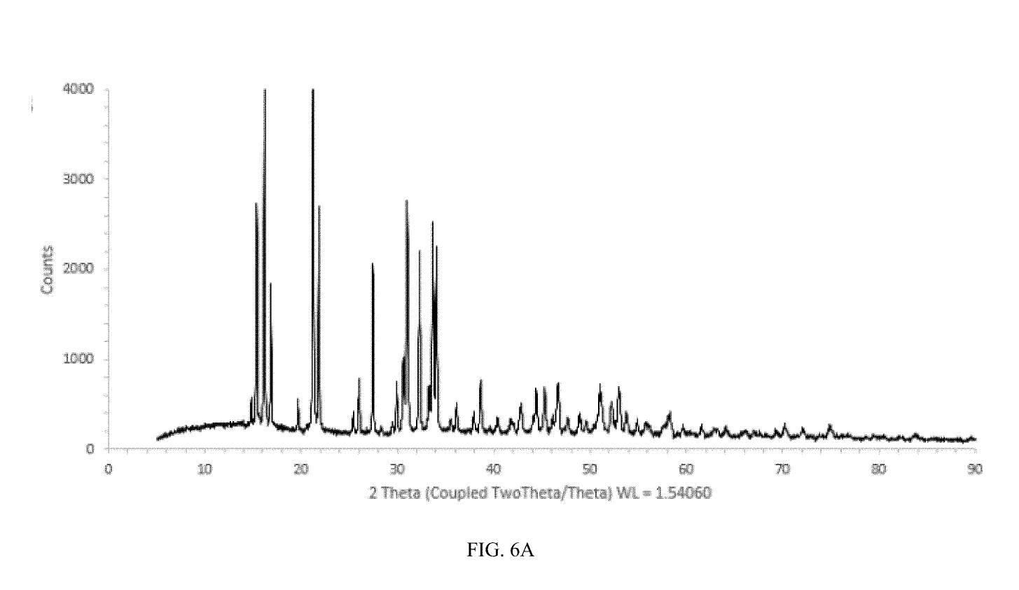

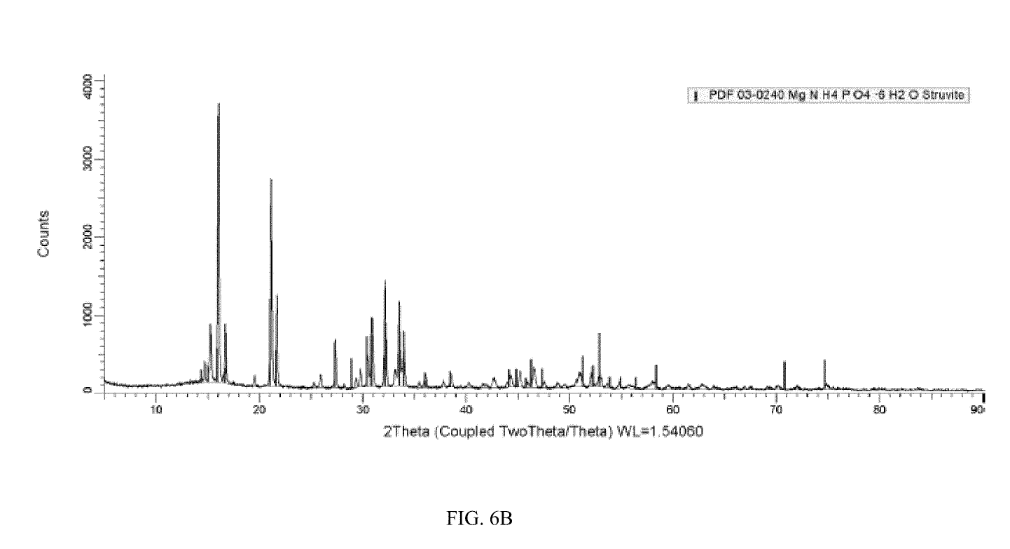

Struvite precipitation recovered approximately 16% of the ammonium and 73% of the phosphate, as shown in FIG. 5. The ammonium removal percentage was in the range of typical commercial options available to recover struvite (ammonium recovery from sidestreams ranged from ˜5-40%); the phosphate recovery percentage was slightly below the typical observed range of ˜80-95%. A comparison of experimental struvite samples with a commercially produced struvite sample using X-ray diffraction is shown in FIGS. 6A and 6B, indicating that the collected precipitate was principally struvite. However, X-ray diffraction results indicated that calcium may be included in both the experimental and Ostara® samples; this may indicate the presence of calcium phosphate, for instance. Nutrient recovery by struvite provides benefits over the removal of nitrogen (e.g., as nitrogen gas) because the nutrients in the struvite were recovered. Because 84% of the influent ammonium remained in the liquid effluent of the struvite precipitation reactor, this liquid was used as the influent to the fixed-film nitrification reactor to further remove nitrogen.

### EXAMPLE 4

### Nitrogen Removal Via Fixed-Film Nitritation and Microbial Fuel Cell

The fixed-film nitrification reactor further decreased the total nitrogen concentration by 37%, from 1530±130 mg N/L in the struvite effluent to 960±150 mg N/L in the fixed-film nitrification reactor effluent during the 28-week operation period (see FIG. 8). This observation was somewhat surprising because the conversion of ammonium to nitrate would not be expected to decrease the total nitrogen concentration. Simultaneous nitrification and denitrification can occur in the fixed-film nitrification reactor. Because carriers were used in the fixed-film nitrification reactor to grow nitrifying bacteria and the aerator was located above the carriers, the fixed-film nitrification reactor may have regions of low dissolved oxygen (DO). The decrease in total nitrogen likely indicated that denitritation occurred in these less-aerated regions, in addition to nitritation occurring in the more-aerated regions. The nitrification effluent (cathodic influent) had an average NH₄⁺—N of 170 mg/L, NO₂⁻—N of 260 mg/L, and NO₃⁻—N of 19 mg/L, indicating that ammonium was primarily being converted into nitrite, not nitrate. Causes of nitritation often include ammonium inhibition or low dissolved oxygen. The nitrification effluent was used as influent to the cathodic chamber.

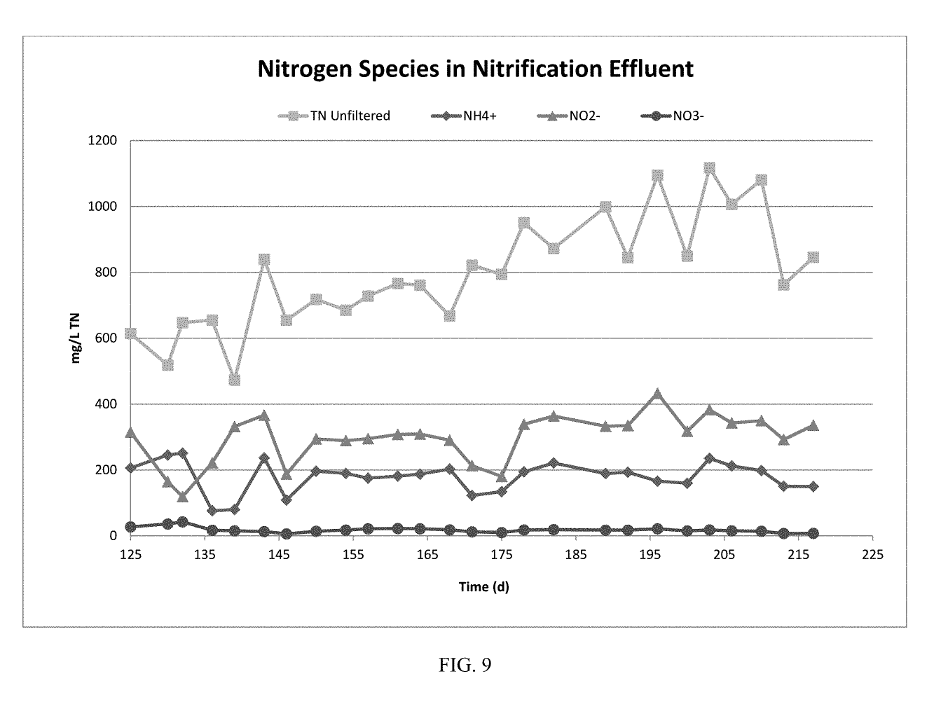

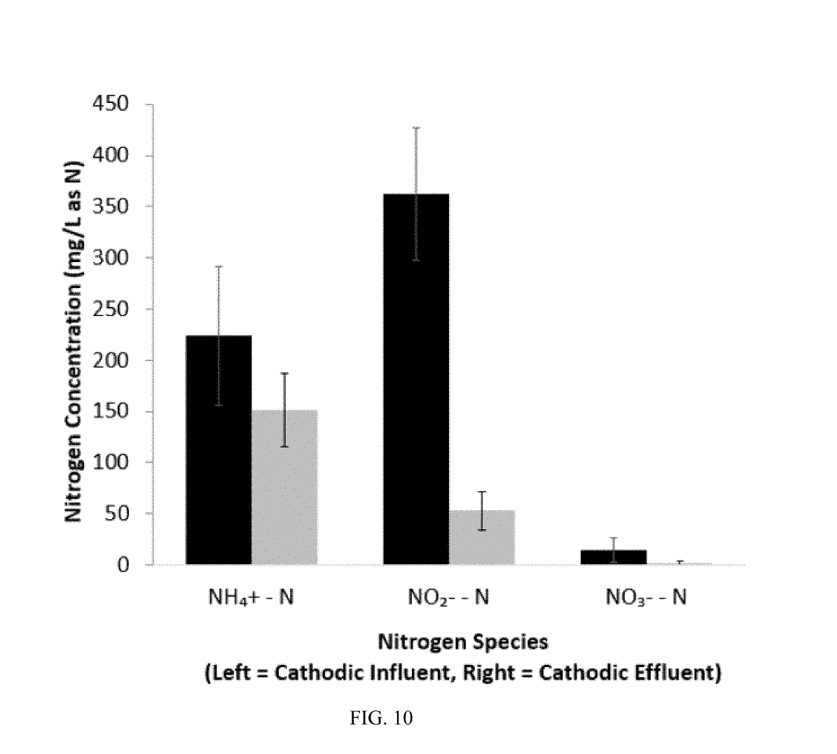

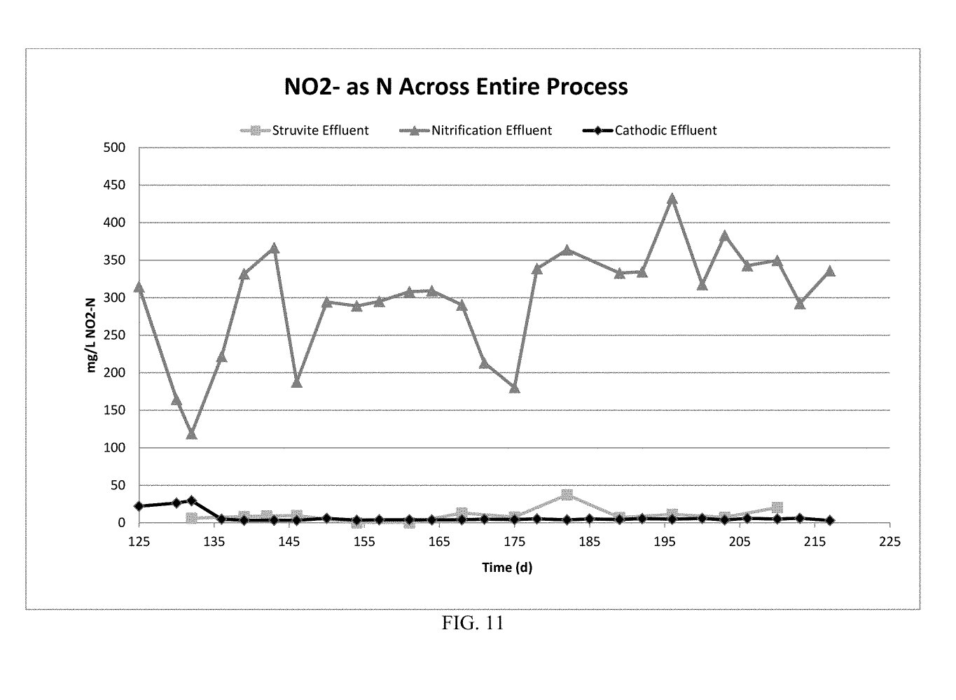

As shown in FIG. 9, the effluent from the fixed-film nitrification reactor was monitored over a 95 day period for total nitrogen, ammonium (NH₄⁺), nitrate (NO₃⁻), and nitrite (NO₂). On average over the course of the study, the fixed-film nitrification reactor effluent had the following nitrogen concentrations: 220±70 mg/L NH₄⁺—N, 360±70 mg/L NO₂⁻—N, and of 14±12 mg/L NO₃⁻—N (FIG. 10). Ammonium and nitrite were responsible for the majority of the total nitrogen found in the nitrification effluent. In fact, the nitrite concentration was monitored across the entire process over a 95 day period and was found to be highest following the nitrification reactor (FIG. 11). These results confirmed that in the fixed-film nitrification reactor ammonium was primarily being converted into nitrite, not nitrate. Nitrite-oxidizing bacteria are suppressed by high concentrations of free ammonia or by low concentrations of dissolved oxygen. Based on the average measured concentration of NH₄⁺—N of 220 mg/L, it was estimated that the free ammonia concentration in the fixed-film nitrification effluent was 0.34 mg/L NH₃—N. Although the fixed-film nitrification reactor was originally intended as a nitrification reactor, the dominant process was nitritation rather than nitrification.

In summary, the fixed-film nitrification effluent (stream 5 in FIG. 15) had the following nitrogen concentrations: 220±70 mg/L NH₄⁺—N, 360±70 mg/L NO₂⁻—N, and of 14±12 mg/L NO₃⁻N. This indicated that ammonium was primarily being converted into nitrite, not nitrate. As has been seen in other studies, nitrite-oxidizing bacteria are suppressed by high concentrations of free ammonia or by low concentrations of DO. Based on the average measured concentration of NH₄⁺—N of 220 mg/L, it was estimated that the free ammonia concentration in the fixed-film nitrification effluent was 0.34 mg/L NH₃—N. This estimated concentration was in the range of 0.1-1 mg/L that has been shown to suppress nitrite-oxidizing bacteria.

Although the fixed-film nitrification reactor was originally intended as a nitrification reactor, and the dominant process was nitritation rather than nitrification. The fixed-film nitrification reactor effluent, which included more nitrite than nitrate, was used as influent to the cathodic chamber of the MFC (see FIG. 15). In the cathodic chamber, the average TN decreased by an additional 24% to approximately 730 mg/L N (SD 110 mg/L). The cathodic effluent had concentrations of 150±40 mg/L NH₄⁺—N, 50±20 mg/L NO₂⁻—N, and 2±2 mg/L NO₃⁻—N over the 28-week operation. The drop in nitrite concentration from 360 mg/L to 50 mg/L indicated that the cathodic chamber primarily utilized denitritation to remove nitrogen. The nitrogen data are shown graphically in FIGS. 8 and 10. The overall nitrogen removal achieved by the treatment process (i.e., from the digester effluent to the MFC cathode effluent) was approximately 74% over the 28-week period of operation.

### EXAMPLE 5

### Performance of the Microbial Fuel Cell

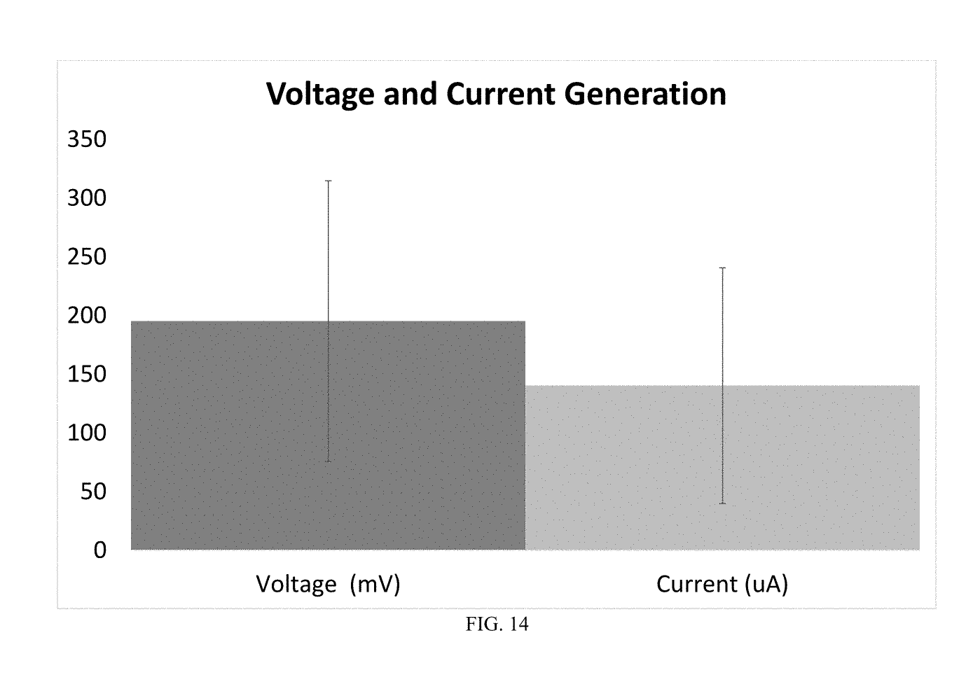

Power production was evident as shown in FIG. 14. Over the course of the entire 28 week study, the microbial fuel cell produced an average voltage of 195 mV and an average current of 141 μA with a Power density of 21.2 mW/m² and a Coulombic efficiency of 15%.

In the anodic chamber, an average of 51% of the influent primary wastewater COD (270±180 mg/L over the 28-week operation period) was removed. This indicated that organic matter was oxidized to carbon dioxide, releasing electrons which could be accepted by the anode and donated in the cathodic chamber. An MFC with glucose as the electron donor in the anodic chamber and nitrate as the electron acceptor in the cathodic chamber can have a standard electromotive force of approximately 1.2 V. If nitrite is the electron acceptor in the cathode instead of nitrate, the standard electromotive force can be approximately 0.9 V. The voltage range of MFCs with organic decomposition in the anodic chamber and oxygen as an electron acceptor in the cathodic chamber can be 300-700 mV due to losses associated with activation, bacterial metabolism, and mass transport. The MFC in this study produced an average voltage of 18 mV, which resulted in a calculated average current of 18 μA. Thus, the MFC generated 0.3 mW/m² (based on the surface area of the anode) or 1.1 mW/m³ (based on the volume of liquid in each chamber of the MFC). This is less than the 8-12 mW/m² measured by Lee et al. (Environ. Sci. Technol. (2013) 34(19), 2727-2736) using a similar setup to remove nitrogen and recover energy from landfill leachate. In some embodiments, internal resistance can be reduced and power production can be increased by reducing electron spacing, reducing membrane fouling, and maintaining good contacts in the circuit. Power production may also depend on the concentrations of the electron donor or acceptor in the MFC.

Based on the observed COD reduction of 0.139 g/L in the anode, anodic chamber volume of 0.1 L, and 8 g of O₂ utilized per mole of electrons donated, 0.0017 moles of electrons were donated through organic decomposition in the anodic chamber over the hydraulic residence time of 19.4 days. Based on the average current of 18 μA, 0.0003 moles of electrons travelled through the wire during the same time period. Therefore, the coulombic efficiency, which is defined as the percentage of electrons in the oxidized substance that are recovered as current, was 18%. 0.0066 moles of electrons were accepted in the cathodic chamber through nitrite reduction (based on observed decrease in nitrite concentration from 360 mg/L NO₂⁻—N to 50 mg/L NO₂⁻—N), which was over three times the amount of electrons produced in the anodic chamber. A large amount of electrons were coming from somewhere other than the current. Ammonium in the cathode may be donating electrons as it was observed that 0.094 g NH₄⁺/L were also removed in the cathodic chamber, which would correspond to 0.00201 moles of electrons, or about one third of the moles of electrons accepted in the cathode. Anaerobic ammonium oxidation (ANAMMOX) may have been occurring in the cathode, which could partially explain the surprisingly high observed removal of nitrite in the cathode.

The disclosed integrated treatment system that combined anaerobic digestion, struvite precipitation and MFC can remove or recover 73% of phosphorus and 74% of nitrogen from anaerobic digester effluent while generating 2.3 W of power (based on the methane yield of 0.2 m³ CH₄/kgVS and an assumed heat value of methane of 36 MJ/m³ CH₄). This may be an improvement over anaerobic digestion followed by technologies such as ANAMMOX that remove up to 90% of ammonium but not phosphorus. This may also be an improvement over implementing only anaerobic digestion and struvite precipitation (without the MFC) because the proposed new technology achieves additional nitrogen removal. The treatment process as demonstrated is not energy-neutral, as the energy input (2.7 W) for the aerator is greater than the energy output of 2.3 W (as methane) from anaerobic digestion and 3.3E-07 W from the MFC.

In some embodiments, power output can be improved by increasing the power production from the anaerobic digester both by modifying operating conditions in the digester (e.g. thermal hydrolysis, two phase anaerobic digestion) and/or the mainstream process (e.g. adding primary treatment, reducing SRT). In some embodiments, power output can be improved by optimizing aeration as nitrite was produced (as opposed to nitrate, which requires more oxygen input). In some embodiments, power output can be improved by maintaining power output after lowering the amount of energy input through the aerator. In some embodiments, power output can be improved by employing other MFC designs that generate more power than the dual-chambered MFC design. In some embodiments, improvements in design, materials, and scalability can increase power output, which is probably best used on-site.

Results demonstrate that combining struvite precipitation and microbial fuel cells recovers nutrients and energy, presenting a promising process to save wastewater treatment plants money by reducing chemical and energy costs.

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof

For reasons of completeness, various aspects of the invention are set out in the following numbered clauses:

Clause 1. A wastewater treatment process comprising: forming struvite precipitation from a liquid influent processed through a wastewater digester to thereby generate a first liquid effluent with a phosphorus concentration of less than 5%; providing the first liquid effluent to a nitrification reactor to convert ammonium in the first liquid effluent to nitrate or nitrite thereby generating a second liquid effluent; providing the second liquid effluent to a microbial fuel cell, wherein the microbial fuel cell includes an anodic chamber for organic decomposition, a cathodic chamber for denitritation/denitrification; and the microbial fuel cell generating energy and a third liquid effluent substantially free of nitrogen and phosphorus.

Clause 2. The wastewater treatment process of clause 1, wherein nitrogen concentration in the first liquid effluent is reduced by 45% in the nitrification reactor.

Clause 3. The wastewater treatment process of clause 1 or 2, further comprising providing aeration to the nitrification reactor.

Clause 4. The wastewater treatment process of any one of clauses 1-3, further comprising adjusting pH to the liquid influent.

Clause 5. The wastewater treatment process of any one of clauses 1-4, further comprising adding primary wastewater (or other electron-donating organic substrates) to the microbial fuel cell.

Clause 6. The wastewater treatment process of any one of clauses 1-5, wherein the microbial fuel cell generates an average voltage in a range of 0 to 500 mV.

Clause 7. The wastewater treatment process of any one of clauses 1-6, wherein the microbial fuel cell generates an average current in a range of 0 to 500 μA.

Clause 8. The wastewater treatment process of any one of clauses 1-7, wherein the microbial fuel cell generates power in a range of 0 to 60 mW/m².

Clause 9. A wastewater treatment process comprising: digesting waste activated sludge in an anaerobic digester to generate an digester effluent; centrifuging the digester effluent to produce a liquid influent; forming struvite precipitation from the liquid influent to thereby generate a first liquid effluent, wherein the phosphorus concentration in the first liquid effluent is reduced compared to the phosphorus concentration in the liquid influent; providing the first liquid effluent to a fixed-film nitrification reactor to convert ammonium in the first liquid effluent to nitrate or nitrite thereby generating a second liquid effluent comprising nitrate, nitrite, or a mixture thereof; and providing the second liquid effluent and an influent primary wastewater or other electron-donating organic substrate to a microbial fuel cell, wherein the microbial fuel cell comprises an anodic chamber for organic decomposition and a cathodic chamber for denitritation, denitrification, or both, wherein the second liquid effluent is provided to the cathodic chamber and the influent primary wastewater or other electron-donating organic substrate is provided to the anodic chamber, whereby the microbial fuel cell generates energy and a third liquid effluent is generated having reduced amounts of nitrogen and phosphorus compared to the waste activated sludge.

Clause 10. The wastewater treatment process of clause 9, wherein nitrogen concentration in the first liquid effluent is reduced by at least about 25% in the fixed-film nitrification reactor.

Clause 11. The wastewater treatment process of clause 9 or 10, wherein the phosphorus concentration in the first liquid effluent is reduced by at least about 70% compared to the phosphorus concentration in the liquid influent.

Clause 12. The wastewater treatment process of any one of clauses 9-11, wherein the third liquid effluent has at least about 50% less phosphorus and/or nitrogen compared to the waste activated sludge.

Clause 13. The wastewater treatment process of any one of clauses 9-12, wherein at least about 40% of the influent primary wastewater chemical oxygen demand (COD) is removed in the microbial fuel cell.

Clause 14. The wastewater treatment process of any one of clauses 9-13, further comprising providing aeration to the fixed-film nitrification reactor.

Clause 15. The wastewater treatment process of clause 14, wherein aeration is provided by a fish-tank aerator.

Clause 16. The wastewater treatment process of any one of clauses 9-15, further comprising adjusting the pH of the liquid influent.

Clause 17. The wastewater treatment process of clause 16, wherein the pH of the liquid influent is adjusted to 8.5.

Clause 18. The wastewater treatment process of any one of clauses 9-17, wherein struvite precipitation is achieved by adding MgCl₂.6H₂O to the liquid influent to achieve an Mg:P molar ratio of 1.6-2.0.

Clause 19. The wastewater treatment process of any one of clauses 9-18, wherein the anaerobic digester is a thermophilic anaerobic digester.

Clause 20. The wastewater treatment process of any one of clauses 9-19, wherein the WAS comprises at least about 3% by mass volatile solids concentration feed sludge.

Clause 21. The wastewater treatment process of any one of clauses 9-20, wherein the anodic chamber of the MFC is inoculated with Shewanella putrefaciens and the cathodic chamber of the MFC is inoculated with Geobacter metallireducens.

Clause 22. The wastewater treatment process of any one of clauses 9-21, wherein the anodic chamber and cathodic chamber are maintained under anoxic conditions.

Clause 23. The wastewater treatment process of any one of clauses 9-22, wherein the influent primary wastewater or other electron-donating organic substrate comprises filtered raw wastewater.

Clause 24. The wastewater treatment process of any one of clauses 9-23, wherein the second liquid effluent comprises more nitrate than nitrite or more nitrite than nitrate.

Clause 25. The wastewater treatment process of any one of clauses 9-24, wherein the microbial fuel cell generates an average voltage in a range of 0 to 500 mV.

Clause 26. The wastewater treatment process of any one of clauses 9-25, wherein the microbial fuel cell generates an average current in a range of 0 to 500 μA.

Clause 27. The wastewater treatment process of any one of clauses 9-26, wherein the microbial fuel cell generates power in a range of 0 to 60 mW/m².

Clause 28. The wastewater treatment process of any one of clauses 9-27, wherein the microbial fuel cell generates power in a range of 0 to 70 mW/m³.

Various features and advantages of the invention are set forth in the following claims.

What is claimed is:

1. A wastewater treatment process comprising:
forming struvite precipitation from a liquid influent processed through a wastewater digester to thereby generate a first liquid effluent with a phosphorus concentration of less than 5%;
providing the first liquid effluent to a nitrification reactor to convert ammonium in the first liquid effluent to nitrate or nitrite thereby generating a second liquid effluent;
providing the second liquid effluent to a microbial fuel cell, wherein the microbial fuel cell includes an anodic chamber for organic decomposition, a cathodic chamber for denitritation/denitrification; and
the microbial fuel cell generating energy and a third liquid effluent substantially free of nitrogen and phosphorus.

2. The wastewater treatment process of claim 1, wherein nitrogen concentration in the first liquid effluent is reduced by at least about 25% in the nitrification reactor.

3. The wastewater treatment process of claim 1, further comprising providing aeration to the nitrification reactor.

4. The wastewater treatment process of claim 1, further comprising adjusting pH to the liquid influent.

5. The wastewater treatment process of claim 1, further comprising adding primary wastewater or other electron-donating organic substrates to the microbial fuel cell.

6. The wastewater treatment process of claim 1, wherein the microbial fuel cell generates an average voltage in a range of 0 to 500 mV and/or an average current in a range of 0 to 500 μA.

7. The wastewater treatment process of claim 1, wherein the microbial fuel cell generates power in a range of 0 to 60 mW/m².

8. The wastewater treatment process of claim 1, wherein the wastewater digester comprises an anaerobic digester.

9. A wastewater treatment process comprising:
digesting waste activated sludge in an anaerobic digester to generate an digester effluent;
centrifuging the digester effluent to produce a liquid influent;
forming struvite precipitation from the liquid influent to thereby generate a first liquid effluent, wherein the phosphorus concentration in the first liquid effluent is reduced compared to the phosphorus concentration in the liquid influent;
providing the first liquid effluent to a fixed-film nitrification reactor to convert ammonium in the first liquid effluent to nitrate or nitrite thereby generating a second liquid effluent comprising nitrate, nitrite, or a mixture thereof; and
providing the second liquid effluent and an influent primary wastewater or other electron-donating organic substrate to a microbial fuel cell, wherein the microbial fuel cell comprises an anodic chamber for organic decomposition and a cathodic chamber for denitritation, denitrification, or both, wherein the second liquid effluent is provided to the cathodic chamber and the influent primary wastewater or other electron-donating organic substrate is provided to the anodic chamber, whereby the microbial fuel cell generates energy and a third liquid effluent is generated having reduced amounts of nitrogen and phosphorus compared to the waste activated sludge.

10. The wastewater treatment process of claim 9, wherein nitrogen concentration in the first liquid effluent is reduced by at least about 25% in the fixed-film nitrification reactor.

11. The wastewater treatment process of claim 9, wherein the phosphorus concentration in the first liquid effluent is reduced by at least about 70% compared to the phosphorus concentration in the liquid influent.

12. The wastewater treatment process of claim 9, wherein the third liquid effluent has at least about 50% less phosphorus and/or nitrogen compared to the waste activated sludge.

13. The wastewater treatment process of claim 9, wherein at least about 40% of the influent primary wastewater chemical oxygen demand (COD) is removed in the microbial fuel cell.

14. The wastewater treatment process of claim 9, further comprising providing aeration to the fixed-film nitrification reactor.

15. The wastewater treatment process of claim 9, further comprising adjusting the pH of the liquid influent.

16. The wastewater treatment process of claim 9, wherein struvite precipitation is achieved by adding MgCl₂.6H₂O to the liquid influent to achieve a Mg:P molar ratio of 1.6-2.0.

17. The wastewater treatment process of claim 9, wherein the anodic chamber of the microbial fuel cell is inoculated with Shewanella putrefaciens and the cathodic chamber of the microbial fuel cell is inoculated with Geobacter metallireducens.

18. The wastewater treatment process of claim 9, wherein the anodic chamber and cathodic chamber are maintained under anoxic conditions.

19. The wastewater treatment process of claim 9, wherein the microbial fuel cell generates an average voltage in a range of 0 to 500 mV and/or an average current in a range of 0 to 500 μA.

20. The wastewater treatment process of claim 9, wherein the microbial fuel cell generates power in a range of 0 to 60 mW/m² and/or 0 to 70 mW/m³.
